(19) United States
(12) Patent Application Publication
(10) Pub. No.: US 2026/0189887 A1
(43) Pub. Date: Jul. 2, 2026

(54) OPTIMIZED 6 GHZ WIFI CONFIGURATION AND REGULATORY COMPLIANCE FOR HIGH-ALTITUDE COMMERCIAL AIRCRAFTS

(71) Applicant: Cisco Technology, Inc., San Jose, CA (US)

(72) Inventors: Sachin D. Wakudkar, St-Sulpice (CH); Ardalan Alizadeh, Milpitas, CA (US); Niloo Bahadori, Greensboro, NC (US); Arya Fallahi, Zurich (CH); Peiman Amini, Fremont, CA (US); Juan Carlos Zuniga, Montreal (CA)

(73) Assignee: Cisco Technology, Inc., San Jose, CA (US)

(21) Appl. No.: 19/253,411

(22) Filed: Jun. 27, 2025

Related U.S. Application Data
(60) Provisional application No. 63/740,768, filed on Dec. 31, 2024.

(51) Int. Cl. H04W 4/42; G01C 21/20; H04W 4/80; H04W 64/00

(52) U.S. Cl. CPC H04W 4/42; G01C 21/20; H04W 4/80; H04W 64/00

(57) ABSTRACT

Optimized wireless configuration and regulatory compliance for vehicles may be provided. A path and a schedule of a vehicle may be received. Then regulatory wireless requirements associated with the path may be received. Next, a profile indicating wireless system configurations for a wireless system associated with the vehicle based on the path, the schedule, and the regulatory wireless requirements may be created. The wireless system may then be configured based on the profile.

### RELATED APPLICATION

Under provisions of 35 U.S.C. § 119(e), Applicant claims the benefit of U.S. Provisional Application No. 63/740,768 filed Dec. 31, 2024, which is incorporated herein by reference.

### TECHNICAL FIELD

The present disclosure relates generally to providing optimized wireless configuration and regulatory compliance for vehicles.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing optimized wireless configuration and regulatory compliance for vehicles;

FIG. 2 is a flow chart of a method for providing optimized wireless configuration and regulatory compliance for vehicles;

FIG. 3 is a flow chart of a method for providing optimized wireless configuration and regulatory compliance for vehicles; and

FIG. 4 is a block diagram of a computing device.

### DETAILED DESCRIPTION

### Overview

Optimized wireless configuration and regulatory compliance for vehicles may be provided. A path and a schedule of a vehicle may be received. Then regulatory wireless requirements associated with the path may be received. Next, a profile indicating wireless system configurations for a wireless system associated with the vehicle based on the path, the schedule, and the regulatory wireless requirements may be created. The wireless system may then be configured based on the profile.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The demand for higher Wi-Fi speeds on aircraft may be critical due to several factors. First, modern aircraft may be equipped with advanced entertainment systems embedded in seatbacks that may offer High Definition (HD) 4K resolution and various content such as movies and flight information. These entertainment systems, along with the increasing use of Personal Electronic Devices (PEDs) for streaming, may require high-speed Wi-Fi that may not be efficiently supported by Local Area Network (LAN) connections due to logistical constraints.

Moreover, aircraft passengers may also expect high-quality, uninterrupted internet access for streaming, browsing, and other online activities. Accordingly, airline companies may be upgrading to high-speed satellite Wi-Fi to meet these demands.

Considering the aforementioned usages, the 5 GHz band may become saturated quickly with many passengers online simultaneously, especially on long-haul flights. Additionally, the 5 GHz band may be more prone to interference from other devices and environmental factors, making it less reliable for consistent coverage throughout a large aircraft. With the growing adoption of Wi-Fi 6E, which operates on the 6 GHz band, higher throughput requirements may be better supported.

Consequently, the 6 GHz band may be essential for providing the necessary bandwidth, reduced interference, and higher capacity to ensure a superior connectivity experience for passengers. However, using the entire 6 GHz band in an aircraft that traverses international borders may be challenging due to international regulatory differences. For example, the United States (US) may allow Unlicensed National Information Infrastructure (UNII)-5 to UNII-8 bands, the United Kingdom (UK) may only allow UNII-5, and some countries may not permit any 6 GHz usage. These regulatory discrepancies may require adaptive solutions to dynamically manage and optimize the available spectrum during international flights, ensuring compliance and maximizing performance.

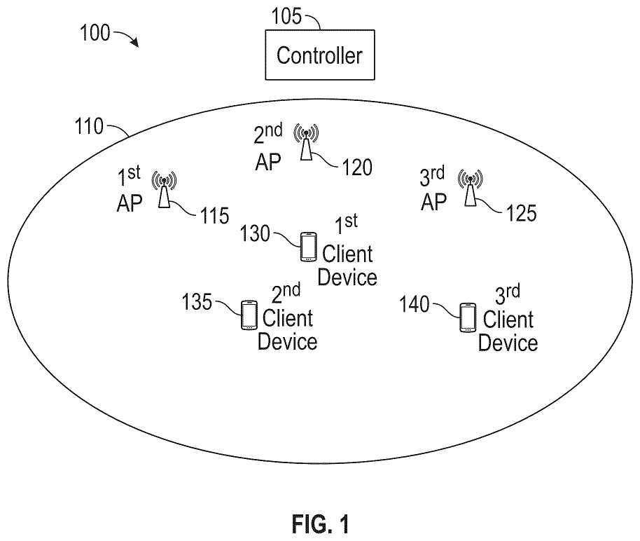

FIG. 1 shows an operating environment 100 for providing optimized wireless configuration and regulatory compliance for vehicles. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN for client devices). The plurality of APs may comprise a first AP 115, a second AP 120, a third AP 125. As described below, the plurality of APs may comprise any number of APs and is not limited to three.

Consistent with embodiments of the disclosure, operating environment 100 may be disposed within a vehicle. The vehicle may traverse international borders where different regulator rules and regulations may be in place. The vehicle may comprise, but is not limited to, and aircraft or maritime ship. The aircraft may comprise a high-altitude commercial aircraft. Notwithstanding, the vehicle may comprise a vehicle other than an aircraft or a maritime ship.

The plurality of APs may provide wireless network access to a plurality of client devices as they move within coverage environment 110. The plurality of client devices may comprise, but are not limited to, a first client device 130, a second client device 135, and a third client device 140. Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard for example.

The plurality of APs and the plurality of client devices may use Multi Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band. The two or more links on any given one of the plurality of client devices may be made with any one AP or with any combination of the APs.

The plurality of APs and the plurality of client devices may also have an Ultra-Wide Band (UWB) radio that may use UWB radio technology using a very low energy level for short-range, high-bandwidth communications over a large portion of the radio spectrum. UWB may transmit information across a wide bandwidth (e.g., >500 MHz). This may allow for the transmission of a large amount of signal energy without interfering with conventional narrowband and carrier wave transmission in the same frequency band. Regulatory limits in many countries may allow for this efficient use of radio bandwidth, and enable high-data-rate personal area network (PAN) wireless connectivity, longer-range low-data-rate applications, and the transparent co-existence of radar and imaging systems with existing communications systems.

Controller 105 may comprise a Wireless Local Area Network controller (WLC) and may provision and control coverage environment 110 (e.g., a WLAN). Controller 105 may allow first client device 130, second client device 135, and third client device 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide optimized wireless configuration and regulatory compliance for vehicles.

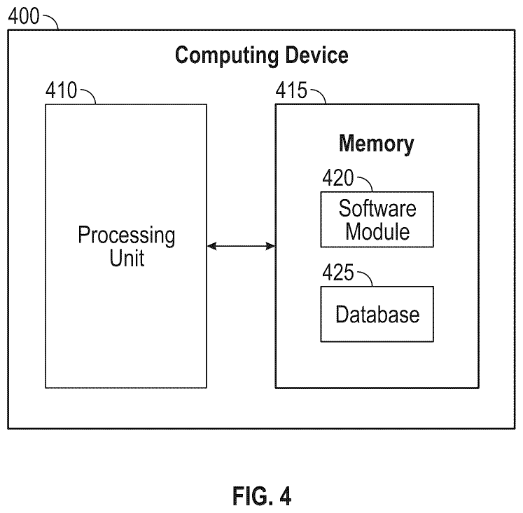

The elements described above of operating environment 100 (e.g., controller 105, first AP 115, second AP 120, third AP 125, first client device 130, second client device 135, or third client device 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 4, the elements of operating environment 100 may be practiced in a computing device 400.

Embodiments of the disclosure may address the challenges of using Automated Frequency Coordination (AFC) bands, such as the 6 GHz band, for Wi-Fi operations in commercial aircraft flying at high altitude (e.g., above 10,000 feet), or in maritime ships. Embodiments may include processes for geolocation, altitude determination, regulatory compliance, and optimal channel selection, ensuring high-speed connectivity and compliance with international regulations for example.

### Static Configuration

The Static Configuration process may involve creating a pre-determined flight path configuration based on the route and countries the vehicle (e.g., aircraft) may cross. This approach may ensure compliance with international regulations by planning ahead and preparing operating environment 100 for expected changes in regulatory environments.

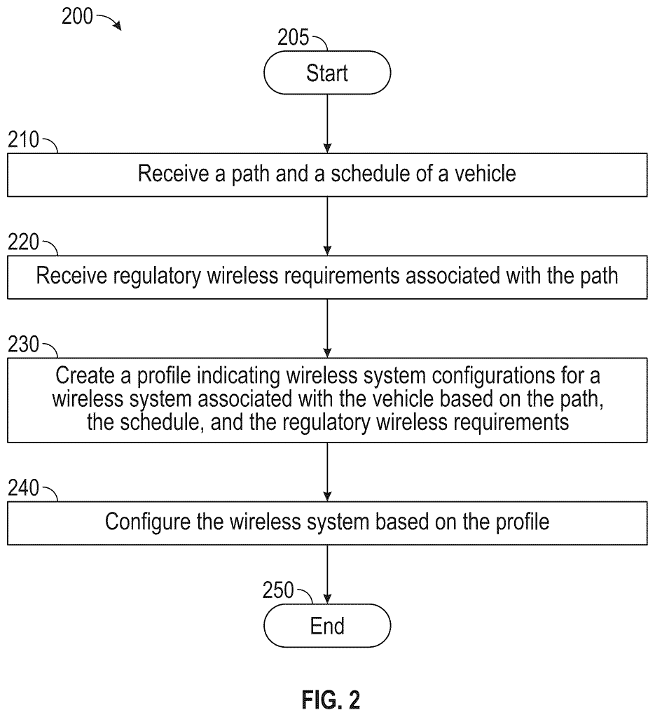

FIG. 2 is a flow chart setting forth the general stages involved in a method 200 consistent with embodiments of the disclosure for providing optimized wireless configuration and regulatory compliance for vehicles. Method 200 may be implemented using a computing device 400 as described in more detail below with respect to FIG. 4. Computing device 400 may be embodied by controller 105 or any of the plurality of APs as described above. Ways to implement the stages of method 200 will be described in greater detail below.

Method 200 may begin at starting block 205 and proceed to stage 210 where computing device 400 may receive a path and a schedule of a vehicle. For example, at the time of departure, computing device 400 may obtain the complete flight path and schedule, including all countries and regulatory zones the vehicle (e.g., aircraft) may traverse.

From stage 210, where computing device 400 receives the path and the schedule of the vehicle, method 200 may advance to stage 220 where computing device 400 may receive regulatory wireless requirements associated with the path. For example, a database of regulatory wireless requirements for each country along the path (e.g., flight path) may be compiled, including allowed channels (e.g., UNII bands), power levels, and any specific restrictions for example.

Once computing device 400 receives the regulatory wireless requirements associated with the path in stage 220, method 200 may continue to stage 230 where computing device 400 may create a profile indicating wireless system configurations for a wireless system (e.g., coverage environment 110) associated with the vehicle. The profile may be based on the path, the schedule, and the regulatory wireless requirements. For example, a profile (e.g., a calendar profile) may be created detailing when to turn Wi-Fi on and off according to the flight path and regulatory requirements for a given country or area the vehicle may be in. This profile may include specific time points and locations where regulatory changes are anticipated thus a change in Wi-Fi configuration may be needed at these points. In other words, Wi-Fi configurations may be planned based on the calendar profile. This includes, for example, selecting appropriate channels (e.g., UNII bands) and power levels that may comply with the regulations of each country the vehicle (e.g., aircraft) may enter. For example, in the US, UNII-5 (5.925-6.425 GHz) to UNII-8 (7.125 GHz) bands my be allowed, while in the UK, only UNII-5 may be permitted.

After computing device 400 creates the profile indicating the wireless system configurations for the wireless system associated with the vehicle in stage 230, method 200 may proceed to stage 240 where computing device 400 may configure the wireless system based on the profile. For example, the plurality of APs in operating environment 100 may be configured to follow the calendar profile, automatically adjusting settings at the predetermined points to ensure continuous compliance with international regulations. Once computing device 400 configures the wireless system based on the profile in stage 240, method 200 may then end at stage 250.

For example, for flights from the US to Canada, the system compiles the regulatory requirements for both the US (e.g., UNII-5 to UNII-8) and Canada (e.g., UNII-5 and UNII-6). A calendar profile may be created indicating the time and location of the border crossing. The APs may be configured to switch to channels and power levels allowed in Canada upon crossing the border. Specifically, this may mean transitioning from US channels 149 to 181 (5.925 -6.425 GHz) and channels 182 to 233 (6.425 -7.125 GHz) to Canadian channels 149 to 181 (5.925 -6.425 GHz) with a maximum power level, for example, around 24 dBm (e.g., for indoor APs). UNII-6 (6.425-6.525 GHz) may be subject to more restrictive power levels.

As another example, for flights from the US to Japan, the system compiles the regulatory requirements for the US (e.g., UNII-5 to UNII-8), international zones, and Japan (e.g., specific bands like UNII-5 with possible restrictions on others). A calendar profile may be created detailing the transition points between different regulatory zones. The APs may be configured to adjust settings as the aircraft enters Japanese airspace. Specifically, the APs may adjust from US channels 149 to 233 (5.925-7.125 GHz) with power levels up to 36 dBm to Japanese channels 149 to 181 (5.925-6.425 GHz) with a maximum power level, for example, around 23 dBm.

As yet another example, for flights from the US to the UK, the system may compile the regulatory requirements for the US (e.g., UNII-5 to UNII-8), the UK (e.g., UNII-5), and any overflight regions. A calendar profile may be created indicating when and where to adjust Wi-Fi settings. The APs may be configured to switch to channels and power levels allowed in the UK upon reaching UK airspace. Specifically, the APs may adjust from US channels 149 to 233 (5.925 -7.125 GHz) with power levels up to 36 dBm to UK channels 149 to 181 (5.925 -6.425 GHz) with a maximum power level, for example, around 20 dBm.

By implementing this Static Configuration process, the system may ensure compliance with international regulations and optimizes performance for passengers. This embodiment may provide a proactive approach, preparing the system to handle regulatory changes before they occur, and ensuring a seamless connectivity experience throughout the flight.

### Dynamic Configuration

In this embodiment, the APs may dynamically adjust configurations based on real-time altitude and geographical location data obtained from the aircraft's navigation systems for example. Embodiments may integrate with onboard instruments such as altimeters and Global Navigation Satellite System (GNSS) receivers, allowing continuous monitoring and adjustment. This may ensure that 6 GHz operations may be activated when the aircraft is above 10,000 feet, for example, and comply with the current country's regulations. The dynamic configuration may provide a flexible and responsive solution to changing conditions, enhancing the reliability and performance of in-flight Wi-Fi.

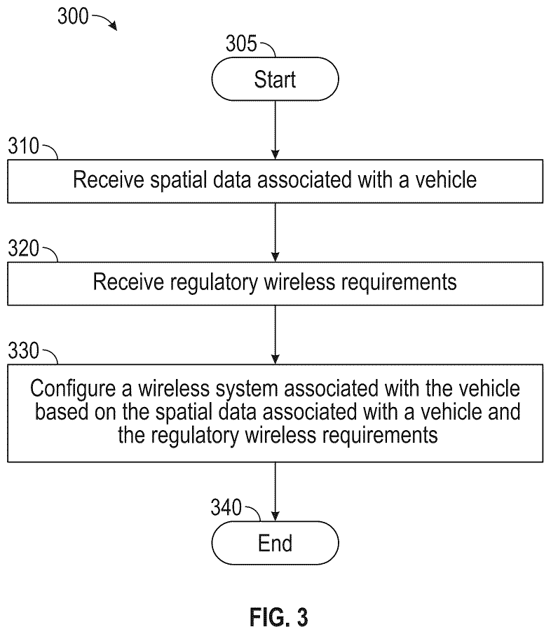

FIG. 3 is a flow chart setting forth the general stages involved in a method 300 consistent with embodiments of the disclosure for providing optimized wireless configuration and regulatory compliance for vehicles. Method 300 may be implemented using a computing device 400 as described in more detail below with respect to FIG. 4. Computing device 400 may be embodied by controller 105 or any of the plurality of APs as described above. Ways to implement the stages of method 300 will be described in greater detail below.

Method 300 may begin at starting block 305 and proceed to stage 310 where computing device 400 may receive spatial data (e.g., altitude and geographical location) associated with a vehicle (e.g., aircraft). For example, computing device 400 may integrate the plurality of APs with the aircraft's navigation systems to continuously receive real-time data on altitude and geographical location. Onboard instruments such as altimeters and GNSS receivers may be used to obtain accurate spatial data (e.g., altitude and geographical location data).

From stage 310, where computing device 400 receives the spatial data associated with the vehicle, method 300 may advance to stage 320 where computing device 400 may receive regulatory wireless requirements. For example, reverse geocoding may be applied to identify a current country based on coordinates (e.g., GNSS coordinates) obtained from the spatial data. A data base may be queried based on the identified current country to obtain the regulatory wireless requirements for the identified current country.

Once computing device 400 receives the regulatory wireless requirements in stage 320, method 300 may continue to stage 330 where computing device 400 may configure a wireless system (e.g., coverage environment 110) associated with the vehicle based on the spatial data associated with a vehicle and the regulatory wireless requirements. For example, the Wi-Fi configurations may be dynamically adjusted based on real-time data to comply with the current country's regulatory environment. Once computing device 400 configures the wireless system associated with the vehicle based on the spatial data associated with a vehicle and the regulatory wireless requirements in stage 330, method 300 may then end at stage 340.

As an example, for flights from the US to Canada, the system may dynamically adjust configurations as the aircraft crosses the border, ensuring compliance with both US and Canadian regulations. Upon reaching 10,000 feet, for example, 6 GHz operations may be activated and altitude may be continuously monitored. As the aircraft approaches the Canadian border, the APs may switch from US channels 149 to 233 (5.925 -7.125 GHz) with power levels up to 36 dBm to Canadian channels 149 to 181 (5.925 -6.425 GHz) with a maximum power level of 24 dBm for indoor APs.

As another example, for flights from the US to Japan, the system may dynamically adjust settings as the aircraft approaches Japanese airspace. Upon crossing into Japanese airspace, the APs may adjust from US channels 149 to 233 (5.925-7.125 GHz) with power levels up to 36 dBm to Japanese channels 149 to 181 (5.925-6.425 GHz) with a maximum power level of 23 dBm.

As yet another example, for flights from the US to the UK, the system may continuously monitor the aircraft's position and adjust settings upon entering UK airspace. The APs may switch from US channels 149 to 233 (5.925 -7.125 GHz) with power levels up to 36 dBm to UK channels 149 to 181 (5.925 -6.425 GHz) with a maximum power level of 20 dBm.

By implementing this Dynamic Configuration process, the system may ensure compliance with international regulations while dynamically adapting to real-time conditions. This embodiment may provide a flexible and responsive approach, maintaining optimal Wi-Fi performance throughout the flight.

### Common Channels Utilization

This embodiment may focus on selecting common channels that may be allowed across different countries to avoid frequent changes and ensure stability. The system may compile a database of commonly allowed channels and prioritizes their use. Embodiments of the disclosure may maintain consistent connectivity by minimizing channel switches as the aircraft (i.e., vehicle) crosses international borders. This approach may enhance user experience by providing a stable and reliable Wi-Fi service throughout the flight. Stages for implementing this process may comprise the following. First, the system may compile a database of channels that are commonly allowed across the countries on the flight path. Next, these common channels may be prioritized in the AP configuration to minimize the need for switching. The APs may then be configured to use these common channels by default, ensuring stable and uninterrupted connectivity.

For example, for flights from the US to Canada, the system may identify common channels allowed in both the US and Canada. Channels 149 to 181 (5.925-6.425 GHz) may be prioritized, for example, as they are allowed in both countries. The APs may be configured to use these channels by default, reducing the need for adjustments upon crossing the border.

As another example, for flights from the US to Japan, the system may identify common channels between the US and Japan. Channels 149 to 181 (5.925-6.425 GHz) may be prioritized, as they are allowed in both countries. The APs may be configured to use these channels, ensuring stable connectivity upon entering Japanese airspace.

In yet another example, for flights from the US to the UK, the system may identify common channels allowed in both the US and the UK. Channels 149 to 181 (5.925 -6.425 GHz) may be prioritized, as they are common to both countries. The APs may be configured to use these channels, ensuring a seamless transition upon entering UK airspace.

By implementing this Common Channels Utilization process, the system may ensure stable and reliable Wi-Fi connectivity throughout the flight, minimizing disruptions due to regulatory changes. This embodiment may comprise the ability to maintain consistent service by leveraging commonly allowed channels across different regions or countries.

### Federated Channels Utilization

As an extension of the Common Channels Utilization process, a set of channels may be statically or dynamically assigned depending on the aircraft's national origin of registration (e.g., as per the International Civil Aviation Organization ICAO) or to the cruise ship's country of origin by some other common law (e.g., Law of the Seas). In this embodiment, an airline's or cruise line's wireless system may be compliant to certain channels depending on its country of origin. In order not to interfere with ground stations, either when on the ground or over the air, channel utilization may only be enabled after the aircraft travels above a certain “safe” altitude, or a ship is far enough away from shore (in the case of maritime vessels), so that no harmful interference may be caused to the closest earth stations, regardless of their regional location.

Embodiments of the disclosure may address the challenges of using the 6 GHz band for Wi-Fi operations in commercial aircraft flying, for example, above 10,000 feet by ensuring regulatory compliance and optimal performance. It may include three embodiments: i) Static Configuration that may plan Wi-Fi settings based on the flight path and regulatory zones; ii) Dynamic Configuration that may adjust settings in real-time based on altitude and geographical data; and iii) Common Channels Utilization that may prioritize commonly allowed channels to maintain stable connectivity. These processes may ensure high-speed connectivity and compliance with international regulations, that may provide a seamless in-flight Wi-Fi experience.

FIG. 4 shows computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for providing optimized wireless configuration and regulatory compliance for vehicles above with respect to FIG. 2 and FIG. 3. Computing device 400, for example, may provide an operating environment for controller 105, first AP 115, second AP 120, third AP 125, first client device 130, second client device 135, or third client device 140. Controller 105, first AP 115, second AP 120, third AP 125, first client device 130, second client device 135, or third client device 140 may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods'stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
receiving a path and a schedule of a vehicle;
receiving regulatory wireless requirements associated with the path;
creating a profile indicating wireless system configurations for a wireless system associated with the vehicle based on the path, the schedule, and the regulatory wireless requirements; and
configuring the wireless system based on the profile.

2. The method of claim 1, wherein the path comprises a route indicating country borders that the vehicle will cross.

3. The method of claim 1, wherein the schedule comprises times that the vehicle will cross country borders.

4. The method of claim 1, wherein receiving the path and the schedule of the vehicle comprises receiving the path and the schedule of the vehicle at a time of departure of the vehicle.

5. The method of claim 1, wherein the wireless system comprises a Wi-Fi system.

6. The method of claim 1, wherein the vehicle comprises an aircraft.

7. The method of claim 1, wherein the vehicle comprises a maritime ship.

8. A method comprising:
receiving spatial data associated with a vehicle;
receiving regulatory wireless requirements; and
configuring a wireless system associated with the vehicle based on the spatial data associated with a vehicle and the regulatory wireless requirements.

9. The method of claim 8, wherein receiving spatial data associated with the vehicle comprises receiving spatial data associated with the vehicle from instruments located in the vehicle.

10. The method of claim 8, wherein the spatial data comprises an altitude of the vehicle.

11. The method of claim 8, wherein the spatial data comprises a geographical location of the vehicle.

12. The method of claim 8, wherein the wireless system comprises a Wi-Fi system.

13. The method of claim 8, wherein the vehicle comprises an aircraft.

14. The method of claim 8, wherein the vehicle comprises a maritime ship.

15. A system comprising:
a memory storage; and
a processing unit disposed in a client device and coupled to the memory storage, wherein the processing unit is operative to:
receive spatial data associated with a vehicle;
receive regulatory wireless requirements;
configure a wireless system associated with the vehicle based on the spatial data associated with a vehicle and the regulatory wireless requirements.

16. The system of claim 15, wherein the processing unit being operative to receive spatial data associated with the vehicle comprises the processing unit being operative to receive spatial data associated with the vehicle from instruments located in the vehicle.

17. The system of claim 15, wherein the spatial data comprises an altitude of the vehicle.

18. The system of claim 15, wherein the spatial data comprises a geographical location of the vehicle.

19. The system of claim 15, wherein the wireless system comprises a Wi-Fi system.

20. The system of claim 15, wherein the vehicle comprises one of an aircraft and a maritime ship.
